(19) United States
(12) Patent Application Publication
(10) Pub. No.: US 2008/0224340 A1
(43) Pub. Date: Sep. 18, 2008

(54) Method of making a polarizing sheet and method of lamination

(76) Inventor: Cheng-Hsin Tsai, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/751,048

(22) Filed: May 21, 2007

(30) Foreign Application Priority Data
Mar. 14, 2007 (TW) 096108746

(51) Int. Cl. B29D 7/01

(52) U.S. Cl. 264/1.34

(57) ABSTRACT

A method of making a polarizing sheet and a related method of lamination are disclosed. The method of making a polarizing sheet includes steps of forming a surface-modified polarizer having carboxylic groups from a polyvinyl alcohol (PVA) film, and then performing a thermocompression lamination to laminate the polarizer with at least one protective film having hydroxyl groups on a surface thereof to form a polarizing sheet.

### BACKGROUND OF THE INVENTION

1. Field of the Invention

The present invention relates to a method of making a polarizing sheet and a related method of lamination.

2. Description of the Prior Art

A polarizing sheet is one of essential components in LCDs. Typically, the polarizing sheet includes a polarizer and at least a protective film. The polarizer typically comprises a film formed of polyvinyl alcohol (PVA) or a derivative thereof and a dichroic material such as iodine or an organic dyestuff adsorbed on the film. The protective film may include, for example, triacetyl cellulose (TAC), polyethylene terephthalate (PET), norbornene, or cycloolefin polymer (COP). Typically, the protective film is adhered to the polarizer through a layer of adhesive. Generally, the adhesive may be a water-soluble aqueous adhesive, such as a polyvinyl alcohol hydrogel or a derivative thereof. Alternatively, the adhesive may be an organic-soluble pressure-sensitive adhesive, UV glue, silicone glue, or a combination thereof. For example, as shown in FIG. 1, a conventional polarizing sheet is consisted of a polarizer 10 and at least a protective film 12 adhered to each other through a layer of adhesive 14. The adhesion between the polarizer 10 and the adhesive 14 or between the adhesive 14 and the protective film 12 is usually generated by means of hydrogen bond and/or cross-linking.

However, when an adhesive is used, strict process conditions and extra processing steps, such as adhesive supply and/or application (coating), adhesion, and drying are required. Accordingly, costs for these equipments are required. Furthermore, the drying step needs a certain time period for the water or organic solvent in the adhesive to be volatilized, and thus the production rate and yield are limited. On the other hand, extra steps represent losses of yield, namely, the raise of production cost. Furthermore, since the water-soluble adhesive is employed, the endurance of the resulting polarizing sheet is usually not satisfiable under the influence of temperature and moisture.

For solving the problems mentioned above, in U.S. Pat. Nos. 6,961,178 and 7,008,504, a method of making a polarizing sheet without adhesives are disclosed. In both methods, the protective film is formed of at least two films having different softening points. When the protective film is heated, the film with the lower softening point is softened. Thereafter, the protective film is laminated with a polarizer in such a way that the softened film of the protective film is adhered to the polarizer. Thereafter, the resulting protective film is cooled and the softened film hardens again, to give an adhesion result. In such methods, adhesives are not used, such that the shortcomings of high cost and poor yields resulting from adhesives are avoided.

However, the cost for making a composite film serving as a protective film is far higher than the cost for making a single film. In addition, the process to make the composite film is very difficult. The composite film includes films having different softening points. When one film with a lower softening point is softened, the other film with a higher softening point is expected to maintain a solid state. Thus, the melting point of each film must be controlled in a precise range. Accordingly, the process is relatively difficult. Moreover, films with different melting points have different heat expansion coefficients. When the composite film serving as the protective film is heated, it tends to warp or curl. In turn, the polarizing sheet obtained after cooling also tends to warp or curl. In addition, the manufacture of the composite film needs more steps than the manufacture of a single film, and, thus, the yield may be reduced and the production cost may be raised.

Therefore, there is still a need for a novel laminating method to make a polarizing sheet without the above-mentioned problems.

### SUMMARY OF THE INVENTION

One objective of the present invention is to provide a method of making a polarizing sheet and a related method of lamination to avoid the above-mentioned shortcomings.

The method of making a polarizing sheet according to the present invention comprises the steps as follows. First, a polarizer is formed from a polyvinyl alcohol (PVA) film, wherein the polarizer is surface-modified to have carboxylic groups. Thereafter, a thermocompression lamination is performed to laminate the polarizer with at least a protective film to form a polarizing sheet. The surface of the protective film used has hydroxyl groups.

The method of lamination according to the present invention comprises steps as follows. First, a first film having carboxylic groups on a surface thereof is provided, and a second film having hydroxyl groups on a surface thereof is provided. Thereafter, a thermocompression lamination is performed to laminate the first film with the second film.

In the method of making a polarizing sheet according to the present invention, the polarizer is surface-modified directly during its manufacturing process, and the surface-modified polarizer is used to laminate with the protective film without using an adhesive. Therefore, the shortcomings caused by the use of adhesives in the conventional manufacturing process are avoided, and, furthermore, the method according to the present invention is simple, fast, and with a relatively low cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing that a polarizer and a protective film are adhered to each other through an adhesive layer therebetween in a prior art;

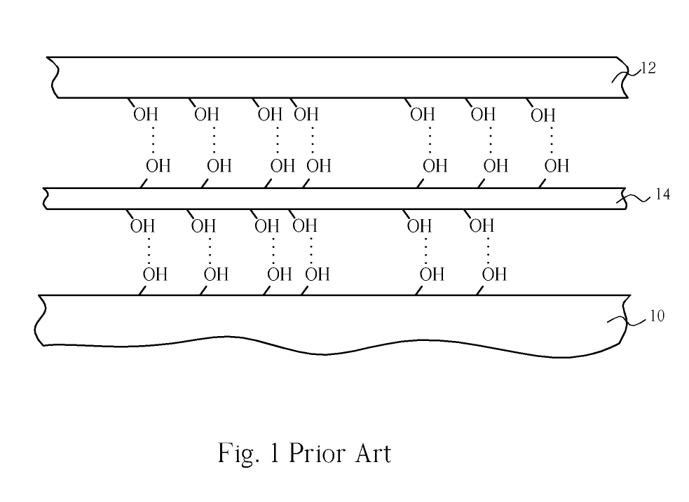

FIG. 2 is a schematic diagram showing an embodiment of the present invention to form a polarizing sheet by performing a step of thermocompression lamination on a polarizer and a protective film;

FIG. 3 is a schematic diagram of a surface configuration of a surface-modified polarizer according to an embodiment of the present invention;

FIG. 4 is a schematic combination diagram showing the adhesion of a surface-modified polarizer to a protective film according to the present invention;

FIG. 5 is a schematic diagram showing a step of preheating before the step of thermocompression lamination in an embodiment of the present invention to form a polarizing sheet;

FIG. 6 is a schematic diagram showing the disposition of tanks for making the polarizer in an embodiment of the present invention; and

FIG. 7 is a data table showing the water resistance test results for the polarizing sheets and the conditions for the lamination of the polarizer and the protective film in Examples 1 to 6 and Comparative Examples 1 to 3.

### DETAILED DESCRIPTION

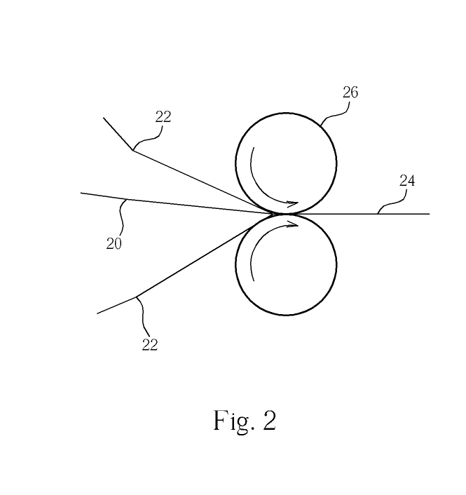

The method of making a polarizing sheet according to the present invention comprises the steps as follows. First, a polarizer is formed from a polyvinyl alcohol (PVA) film, wherein the polarizer is surface-modified to carry carboxylic groups. Next, please refer to FIG. 2. A thermocompression lamination is performed to laminate a surface-modified polarizer 20 with at least a protective film 22 to form a polarizing sheet 24. The protective film 22 used has a surface having hydroxyl groups thereon. The thermocompression lamination may be performed using, for example, pinch rollers 26 under heating.

The present invention is further described in details hereinafter. First, a polarizer is formed from a PVA film. In addition, the polarizer is allowed to carry carboxylic groups on its surface by means of surface modification. The method for accomplishing the surface modification is not particularly limited and may be for example a chemical or physical method. The chemical method for the surface modification is to effect a chemical reaction between the hydroxyl groups exposed on the surface of the PVA film (or its derivative) and active chemicals to produce carboxylic groups carried on the PVA film, by, for example, allowing the PVA film to contact with the chemicals, such as, dipping the PVA film in a liquid or solution containing the chemicals. The carboxylic groups formed can react with hydroxyl groups. The chemicals may comprise a carboxylic acid containing at least two carboxylic groups or a derivative thereof and at least a catalyst. When the PVA film is treated with such chemicals, a large amount of the hydroxyl groups on the PVA surface form ester bonds on the PVA surface in the presence of a proper amount of the catalyst. Since the carboxylic acid used has at least two carboxylic groups, during the reaction, some carboxylic acid molecules each offer one or more carboxylic groups to react with the hydroxyl groups to form the ester bonds, while some un-reacted carboxylic groups are remained, such that the surface of the surface-modified polarizer carries carboxylic groups. Such carboxylic groups carried on the surface of the surface-modified PVA film (i.e. the polarizer) are to be utilized in the lamination of the polarizer with the protective film having hydroxyl groups on its surface in the subsequent step of thermocompression lamination.

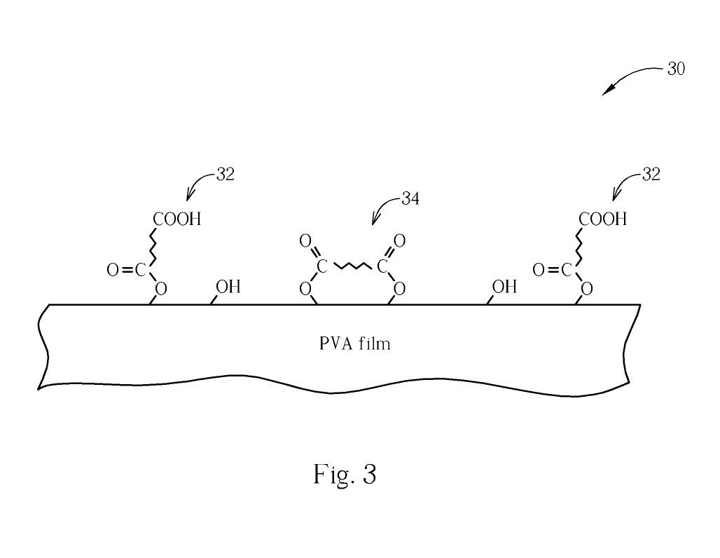

FIG. 3 is a schematic diagram showing a surface configuration of a surface-modified polarizer 30. Taking adipic acid as an example, adipic acid having a molecular formula as HOOCC₄H₈COOH is a dicarboxylic acid comprising six carbon atoms, and thus it has different configurations in space. Both ends of the adipic acid molecule have a carboxylic group. One of the two may react with the hydrophilic hydroxyl group on the surface of the PVA film in an esterification reaction to form a chemical bonding structure 32. Or both of the two may react respectively with the hydrophilic hydroxyl group on the surface of the PVA film in an esterification reaction to form a chemical bonding structure 34. The chemical bonding structure 32 having a carboxylic group remaining at one end will be utilized in the method according to the present invention.

The carboxylic acid containing at least two carboxylic groups or a derivative thereof used may be an organic acid, or its derivative, having two carboxylic groups, and it may include, for example, ethanedioic acid, propanedioic acid, butanedioic acid, glutaric acid, adipic acid, pimelic acid, or a derivative thereof. That is, as long as a carboxylic acid or its derivative having at least two carboxylic groups, it can be used in the present invention. A salt thereof also can be used, but an acid is required to make the reaction solution to be acidic during the reaction.

The amount of the carboxylic acid containing at least two carboxylic groups or a derivative thereof is not particularly limited, as long as the carboxylic acid or the derivative can form an ester bond with the hydroxyl group of the PVA film and one un-reacted carboxylic group can be remained. When the reaction for the surface modification is carried out in a solution, the amount of the carboxylic acid or the derivative used is preferably one such that it may be fully dissolved at a given reaction temperature. For example, in a solution, the concentration of the carboxylic acid or the derivative may be in a range of about 1 to 10 weight %, and more preferably 1 to 5 weight %, but not limited thereto.

The suitable catalyst may be for example a Lewis acid, such as zinc ions (Zn²⁺) or aluminum ions (Al³⁺), or any salt or complex which can provide Zn²⁺ or Al³⁺, such as ZnCl₂, AlCl₃, Al₂(SO₄)₃, ZnSO₄, and the like. The concentration of the catalyst is not particularly limited, as long as the carboxylic groups can bond with the hydroxyl group of PVA film. The concentration of the catalyst in the reaction solution may be, but not limited to, about 0.01 to 3 weight %, preferably 0.01 to 1 weight %, and more preferably 0.01 to 0.1 weight %.

The temperature of the reaction solution may be adjusted as desired without particular limitation. Typically, the temperature ranges from 30° C. to 55° C., but is not limited thereto, in a conventional processing tank for making polarizing sheets. Such range of temperature may be used in the method of the present invention.

For a conventional process to make a polarizer, the process includes at least steps of dyeing, stretching, and color fixation, before the obtained polarizer is dried. These steps are generally performed by dipping in a liquid or solution containing chemicals. One or more additional steps such as swelling and rinsing are optional. The chemicals for performing the above-mentioned steps are placed in tanks, which may be correspondingly named a dyeing tank, a stretching tank, a color fixation tank, a swelling tank, and a rinsing tank. The conventional method of making a polarizer comprises steps as follows: dipping a PVA film in water for swelling, dipping the swelled PVA film in a dye solution for dyeing, dipping the dyed PVA film in a boric acid solution for stretching, and drying the stretched PVA film, to form a polarizer. In the method of the present invention, the method of making a polarizer further comprises a step of surface modification. This step of surface modification may be incorporated into the above-mentioned steps or performed alone in a separate tank. For example:

Performing the surface modification after the swelling, that is, after the PVA film is swelled, the PVA film is surface-modified to carry carboxylic groups, and thereafter, the surface-modified PVA film is dipped in the dye solution for the dyeing and the subsequent steps for making a polarizer are performed; or

Performing the surface modification at the same time when the swelling is performed, that is, the PVA film is dipped in water for swelling, and at the same time, the PVA film is surface-modified to carry carboxylic groups, and thereafter, the swelled and surface-modified PVA film is dipped in the dye solution for the dyeing and the subsequent steps are performed to make a polarizer; or

Performing the surface modification after the dyeing, that is, after the PVA film is dyed, the PVA film is surface-modified to carry carboxylic groups, and thereafter, the surface-modified PVA film is dipped in the boric acid solution for the stretching and the subsequent steps are performed to make a polarizer; or

Performing the surface modification at the same time when the dyeing is performed, that is, the swelled PVA film is dipped in the dye solution for dyeing, and at the same time, the PVA film is surface-modified to carry carboxylic groups, and thereafter, the dyed and surface-modified PVA film is dipped in the boric acid solution for the stretching and the subsequent steps are performed to make a polarizer; or

Performing the surface modification at the same time when the stretching is performed, that is, the dyed PVA film is dipped in the boric acid solution for stretching, and at the same time, the PVA film is surface-modified to carry carboxylic groups, and thereafter, the stretched and surface-modified PVA film is subjected to the subsequent steps for making a polarizer; or

Performing the surface modification after the stretching, that is, the stretched PVA film is surface-modified to carry carboxylic groups, and thereafter, the surface-modified PVA film is subjected to the subsequent steps for making a polarizer.

The stretched PVA film may be optionally rinsed with water, or further color fixed in a color fixation tank. The rinsing tank and the fixation tank may comprise boric acid and potassium iodide, and the concentration can be adjusted as desired. The concentration may be preferably about 1 to 5 weight % respectively. The ratio is usually about equal to the ratio between boric acid and potassium iodide in the stretching tank, and thus properties of PVA films can be further improved. The rinsing process may be performed again if desired. A rinsing tank usually used in a conventional process may be used in the present invention to rinse the PVA film. Cold water around 10C or lower may be used as a rinsing solution to remove chemical residue on the PVA film surface, before the PVA film is dried.

Finally, the PVA film may be optionally further dried to form the surface-modified polarizer in the present invention. After the surface-modified polarizer is obtained, it is laminated with at least a protective film having hydroxyl groups by a thermocompression process to form a polarizing sheet according to the present invention.

The suitable protective film is not particularly limited except that it must carry hydroxyl groups on its surface for use in the present invention to be laminated with the surface-modified polarizer. The protective film may include, for example, triacetyl cellulose (TAC) films, diacetyl cellulose (DAC) films, a polyvinyl ester hydrolysate, partially dehydrated PVA film, a plasma- or corona-treated film, a film coated with a polymer having hydroxyl groups, a film coated with a resin having hydroxyl groups, or the like. The plasma- or corona-treated film may comprise cyclic olefin polymer (COP), polycarbonate (PC), or cyclic olefin copolymer (COC).

Before the protective film is laminated with the surface-modified polarizer, a treatment may be carried out in advance to improve the adhesion. The treatment may be an alkaline etching, such as, to etch the surface of the protective film with sodium hydroxide and/or potassium hydroxide; a plasma treatment, such as, to attack the surface of protective film using a plasma with a high voltage for allowing the protective film surface to subsequently react with ambient moisture to carry hydroxyl groups; a corona treatment, such as, to perform an electrostatic discharge for allowing the protective film surface to subsequently react with ambient moisture to carry hydroxyl groups; and a coating treatment, such as, to apply a polymer and/or resin having hydroxyl groups, such as polyvinyl alcohol, on the protective film. One of the treatments or a combination thereof may be carried out.

The thermocompression step in the present invention is to allow the surface of the surface-modified polarizer and the surface of the protective film to contact with each other tightly under a pressure provided by pinch rollers under heating, and in turn to cause a chemical reaction providing the adhesion. The temperature for heating the pinch rollers is not particularly limited, as long as a sufficient amount of heat can be provided to cause the reaction between the protective film and the surface-modified polarizer. Problems, such as warps, curls, cracks, and the like, likely occur when the protective film and the polarizer are overheated. To avoid such problems, the temperature for heating is preferably 80 to 200° C., and more preferably 90 to 150° C. Heating time (that is, the time needed for the thermocompression) is not particularly limited and preferably less than 5 seconds. The pressure provided by the pinch rollers to perform the thermocompression is not particularly limited, as long as the pressure is sufficient for the lamination of the protective film and the surface-modified polarizer.

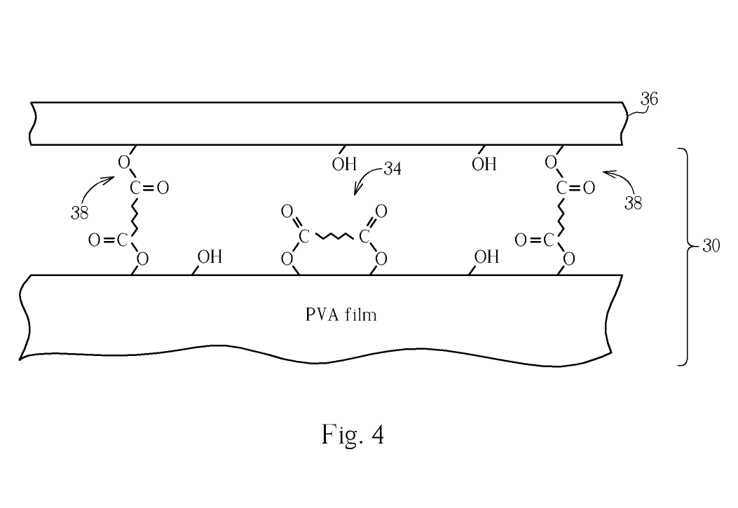

FIG. 4 is a schematic combination diagram showing the adhesion of a surface-modified polarizer to a protective film according to the present invention. The carboxylic groups carried on the surface of the polarizer 30 react with the hydroxyl groups on the surface of the protective film 36 to form ester groups 38, leading a good adhesion.

A preheating step may be optionally performed before the lamination of the protective film and the surface-modified polarizer, such that the polarizing sheet obtained may have a certain adhesion strength even using pinch rollers at a relatively lower temperature. When the protective film is preheated, the heat may be transferred faster from the pinch rollers to the interface of the protective film and the polarizer to cause a chemical reaction. The preheating step may be accomplished by, for example, oven, IR, or additional heating rollers. The temperature for the preheating is not particularly limited as long as un-desired defects, such as warps, curls or recesses, will not occur to the protective films. Various ways for performing the preheat step can be used alone or in a combination.

Before the lamination, a wetting liquid may be further added to an interface between the polarizer and the protective film to help expelling air bubbles to improve the tight lamination of the polarizer and the protective film. The wetting liquid may also serve as a reaction medium for accelerating the reaction.

The ingredients of the wetting liquid are not particularly limited, as long as they do not cause undesired defects on the surface of the polarizer or the protective film. For example, water or a volatile organic solvent with a low boiling point, such as alcohol, especially having a low carbon number, such as methanol, ethanol, propanol, isopropanol and the like, may be used alone or in a combination. Furthermore, a catalyst to help the chemical reaction may be optionally added to the wetting liquid to catalyze the reaction between the hydroxyl groups of the protective film and the carboxylic groups of the surface-modified polarizer to form the ester groups. The catalyst may comprise, for example, a protic acid or a Lewis acid. The protic acid may be, for example, sulfonic acid, hydrochloric acid, sulphuric acid, or nitric acid. The Lewis acid may be for example an aluminum ion or a zinc ion. These catalysts may be used alone or in a combination. The concentration of the catalyst is not particularly limited, and it may be adjusted depending on the heating temperature and the heating time of the pinch rollers.

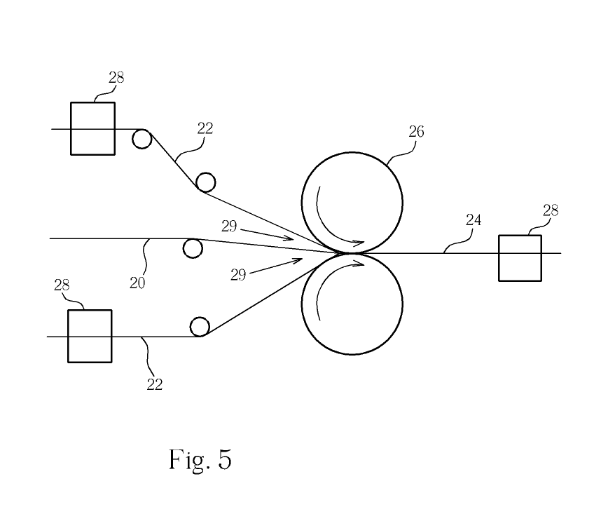

FIG. 5 is a schematic diagram showing a step of preheating before the step of thermocompression lamination in an embodiment of the present invention. The protective film 22 is preheated in an oven 28 before the lamination and then laminated with the polarizer 20 in the step of thermocompression lamination. In addition, a wetting liquid 29 is added to the interface between the polarizer 20 and the protective film 22. After the thermocompression lamination, a polarizing sheet 24 is obtained and may be further dried in the oven 28.

In another aspect of the present invention, a method of lamination is provided. The method of lamination according to the present invention comprises providing a first film having carboxylic groups on a surface thereof and a second film having hydroxyl groups on a surface thereof; and performing a thermocompression lamination to laminate the first film with the second film. The surface of the first film has carboxylic groups. For example, the first film may be the surface-modified polarizer having carboxylic groups as mentioned above, but is not limited thereto. The surface of the second film has hydroxyl groups. The second film may be the protective film having hydroxyl groups on its surface as mentioned above, but is not limited thereto. The first film and the second film are laminated together by the thermocompression lamination. During the thermocompression lamination, the carboxylic group and the hydroxyl group are caused to undergo an esterification reaction by heating, and the first film and the second film can adhere to each other tightly by pressure. The step of thermocompression lamination in the method of making a polarizing sheet according to the present invention described above can be suitably used for the thermocompression lamination in the method of lamination and therefore a further description is omitted.

Some examples are described hereinafter to detail the method of making a polarizing sheet according to the present invention and some comparative examples are described for comparison.

### EXAMPLES

### Example 1

Preparation of a Surface-Modified Polarizer

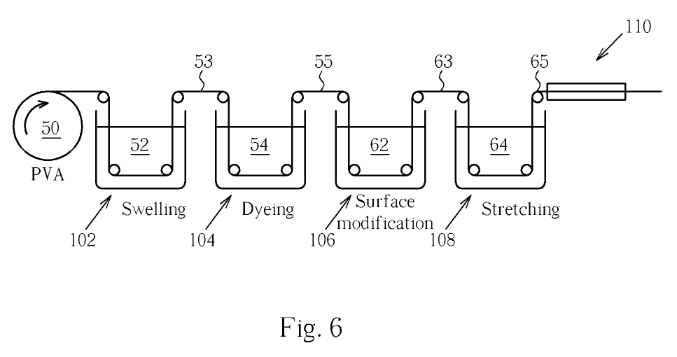

Please refer to FIG. 6 showing the disposition of tanks. First, in Step 102, an unstretched PVA film 50 was dipped and swelled in pure water 52. In Step 104, the resulting PVA film 53 after dipped and swelled was dipped in a dye solution such as a solution containing iodine 54, such that the PVA film 53 adsorbed iodine. The solution containing iodine 54 contained iodine molecules and potassium iodide. The concentration of iodine (including iodine molecules and iodide ions) was about 0.01 to about 1 weight %. In Step 106, the resulting PVA film 55 after dyed was placed in a treating solution 62 for surface modification. The treating solution 62 contained adipic acid in a concentration of 2 to 3 weight % and the catalyst, Al³⁺, in a concentration of 0.01 to 0.1 weight % and was at a temperature of about 35° C.

Next, in Step 108, the PVA film 63 after surface-modified was stretched. The PVA film 63 was placed in a stretching solution 64 containing boric acid and potassium iodide for stretching, for example, uniaxially stretching. In the stretching solution, the concentration of boric acid was 3 to 5 weight %, the concentration of potassium iodide was 3 to 5 weight %, and the temperature was 50 to 52° C. The PVA film 65 after stretching may optionally be further rinsed and color fixed (not shown in FIG. 6). The optional rinsing solution and the optional color fixation solution may both contain boric acid and potassium iodide in a concentration of 1 to 5 weight %. Then the PVA film may be further rinsed again in an ice-cold water (at about 10° C.) to remove residual chemicals on the PVA film surface (not shown in FIG. 6). Finally, in Step 110, the PVA film was dried to form a surface-modified polarizer in the present invention.

Thermocompression Lamination

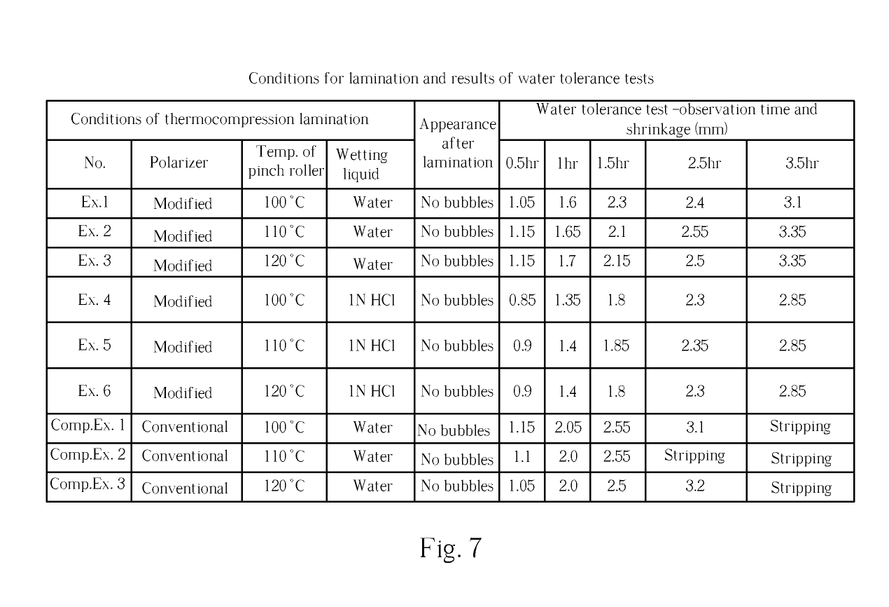

Two triacetyl cellulose (TAC) films each having a thickness of 80 μm and a contact angle of water of 20 to 30 degrees and etched by an alkaline solution (a sodium hydroxide or potassium hydroxide solution) were used to serve as two protective films. A thermocompression lamination was performed using water as a wetting liquid and a pinch roller at a temperature of 100° C. to make a polarizing sheet according to the method of the present invention. The condition for the lamination of the surface-modified polarizer and the protective film is shown in the data table of FIG. 7.

Water Resistance Test

A test sample of 5 cm (traverse direction, TD)×3 cm (machine direction, MD) was cut from the polarizing sheet obtained along the absorption axial direction (that is, machine direction). The test sample was directly dipped in a hot water at 70° C. and the shrinkage of the test sample in machine direction was measured by a vernier caliper on a time schedule. Test results are shown in the table of FIG. 7.

### Examples 2 and 3

The preparation of the surface-modified polarizer, the thermocompression lamination, and the water resistance test were performed using the same method as described in Example 1, except that the pinch roller temperatures for thermocompression were 110°0 C. and 120° C. in Examples 2 and 3, respectively. The conditions for the lamination of the surface-modified polarizer and the protective film and the water resistance test results of the polarizing sheets are shown in the data table of FIG. 7.

### Examples 4, 5 and 6

The preparation of the surface-modified polarizer, the thermocompression lamination, and the water resistance test were performed using the same method as described in Example 1, except that an 1N of hydrochloric acid solution was used as a wetting liquid in Examples 4, 5, and 6 and the pinch roller temperatures for thermocompression were 100° C., 110° C. and 120° C. in Examples 4, 5, and 6, respectively. The conditions for the lamination of the surface-modified polarizer and the protective film and the water resistance test results of the polarizing sheets are shown in the data table of FIG. 7.

### Comparative Example 1

Preparation of a Conventional Polarizer

A polarizer was prepared in the same method as described in Example 1, except that a mixed solution of boric acid and potassium iodide was used instead of the treating solution for surface modification used in the treating tank. Accordingly, the polarizer was prepared without surface modification. The concentration of boric acid was 2 to 5 weight % and the concentration of potassium iodide was 2 to 5 weight %.

Thermocompression Lamination and Water Resistance Test

A polarizing sheet was made by laminating the conventional polarizer obtained with a protective film, using the same thermocompression lamination as described in Example 1. The resulting polarizing sheet was tested for water resistance using the same testing method described in Example 1. The conditions for the lamination and the water resistance test results are shown in the data table of FIG. 7.

### Comparative Examples 2 and 3

The preparation of the conventional polarizer, the thermocompression lamination, and the water resistance test were performed using the same method as described in Comparative Example 1, except that the pinch roller temperatures for the thermocompression were 110° C. and 120° C. in Comparative Examples 2 and 3, respectively. The conditions for the lamination and the water resistance test results are shown in the data table of FIG. 7.

In view of the table of FIG. 7, with respect to the polarizing sheets obtained in Examples 1 to 6 using the method according to the present invention, there were no bubbles produced after the lamination, the shrinkages of the polarizing sheets dipped in water for various periods of time are smaller than those of Comparative Examples 1 to 3, and stripping did not occur after the polarizing sheets were dipped for 3.5 hours. Therefore, the lamination properties for the polarizing sheets obtained using the method according to the present invention are excellent as compared with those obtained using the conventional polarizer.

Those skilled in the art will readily observe that numerous modifications and alterations of the device and method may be made while retaining the teachings of the invention.

What is claimed is:

1. A method of making a polarizing sheet, comprising steps of:
forming a polarizer from a polyvinyl alcohol (PVA) film, wherein the polarizer is surface-modified to carry carboxylic groups; and
performing a thermocompression lamination to laminate the polarizer with at least a protective film having hydroxyl groups on a surface thereof.

2. The method according to claim 1, wherein the polarizer is surface-modified by carrying out a reaction between a carboxylic acid containing at least two carboxylic groups or a derivative thereof and the hydroxyl groups of the PVA film in a presence of a catalyst to form ester bonds, such that the surface of the resulting polarizer carries carboxylic groups.

3. The method according to claim 2, wherein the carboxylic acid comprises ethanedioic acid, propanedioic acid, butanedioic acid, glutaric acid, adipic acid, or pimelic acid.

4. The method according to claim 2, wherein the catalyst comprises a Lewis acid.

5. The method according to claim 4, wherein the Lewis acid comprises an aluminum ion, a zinc ion, a metal salt having an aluminum ion or a zinc ion, or a metal complex having an aluminum ion or a zinc ion.

6. The method according to claim 1, wherein forming the polarizer from the polyvinyl alcohol (PVA) film comprises steps of:
swelling the PVA film in water;
surface-modifying the swelled PVA film to allow the surface of the swelled PVA film to carry carboxylic groups;
dip-dyeing the surface-modified PVA film in a dye solution;
stretching the dip-dyed PVA film in a boric acid solution; and
drying the stretched PVA film to form the polarizer.

7. The method according to claim 1, wherein forming the polarizer from the polyvinyl alcohol (PVA) film comprises steps of:
swelling the PVA film in water and simultaneously surface-modifying the PVA film to allow the surface of the PVA film to carry carboxylic groups;
dip-dyeing the swelled and surface-modified PVA film in a dye solution;
stretching the dip-dyed PVA film in a boric acid solution; and
drying the stretched PVA film to form the polarizer.

8. The method according to claim 1, wherein forming the polarizer from the polyvinyl alcohol (PVA) film comprises steps of:
swelling the PVA film in water;
dip-dyeing the swelled PVA film in a dye solution;
surface-modifying the dip-dyed PVA film to allow the surface of the dip-dyed PVA film to carry carboxylic groups;
stretching the surface-modified PVA film in a boric acid solution; and
drying the stretched PVA film to form the polarizer.

9. The method according to claim 1, wherein forming the polarizer from the polyvinyl alcohol (PVA) film comprises steps of:
swelling the PVA film in water;
dip-dyeing the swelled PVA film in a dye solution and simultaneously surface-modifying the swelled PVA film to allow the surface of the swelled PVA film to carry carboxylic groups;
stretching the dip-dyed and surface-modified PVA film in a boric acid solution; and
drying the stretched PVA film to form the polarizer.

10. The method according to claim 1, wherein forming the polarizer from the polyvinyl alcohol (PVA) film comprises steps of:
swelling the PVA film in water;
dip-dyeing the swelled PVA film in a dye solution;
stretching the dip-dyed PVA film in a boric acid solution and simultaneously surface-modifying the dip-dyed PVA film to allow the surface of the dip-dyed PVA film to carry carboxylic groups; and
drying the stretched and surface-modified PVA film to form the polarizer.

11. The method according to claim 1, wherein forming the polarizer from the polyvinyl alcohol (PVA) film comprises steps of:
swelling the PVA film in water;
dip-dyeing the swelled PVA film in a dye solution;
stretching the dip-dyed PVA film in a boric acid solution;
surface-modifying the stretched PVA film to allow the surface of the stretched PVA film to carry carboxylic groups; and
drying the surface-modified PVA film to form the polarizer.

12. The method according to claim 1, wherein the protective film comprises an alkaline solution-dipped cellulose film, a derivative of an alkaline solution-dipped cellulose film, a polyvinyl ester hydrolysate, partially dehydrated PVA film, a plasma- or corona-treated film, a film coated with a polymer having hydroxyl groups, or a film coated with a resin having hydroxyl groups.

13. The method according to claim 12, wherein the cellulose film comprises a triacetyl cellulose (TAC) film or a diacetyl cellulose (DAC) film.

14. The method according to claim 12, wherein the plasma- or corona-treated film comprises cyclic olefin polymer (COP), polycarbonate (PC), or cyclic olefin copolymer (COC).

15. The method according to claim 1, before performing a thermocompression lamination, further comprising a step of adding a wetting liquid between the polarizer and the protective film.

16. The method according to claim 15, wherein the wetting liquid comprises water, or an organic solvent having a low boiling point.

17. The method according to claim 15, wherein the wetting liquid comprises a catalyst for catalyzing a reaction between a hydroxyl group and a carboxylic group to form an ester group.

18. The method according to claim 17, wherein the catalyst comprises a protic acid or a Lewis acid.

19. The method according to claim 1, before performing the thermocompression lamination, further comprising a step of preheating the protective film.

20. A method of lamination, comprising steps of:
providing a first film having carboxylic groups on a surface thereof;
providing a second film having hydroxyl groups on a surface thereof; and
performing a thermocompression lamination to laminate the first film with the second film.

21. The method according to claim 20, wherein the first film is subjected a surface modification to have the carboxylic groups on the surface thereof.

22. The method according to claim 21, wherein the first film originally had hydroxyl groups and the surface modification is performed using a carboxylic acid containing at least two carboxylic groups or a derivative thereof to react with the hydroxyl groups of the first film in a presence of a catalyst to form ester bonds, such that the surface of the first film carries carboxylic groups.

23. The method according to claim 22, wherein the carboxylic acid comprises ethanedioic acid, propanedioic acid, butanedioic acid, glutaric acid, adipic acid, or pimelic acid.

24. The method according to claim 22, wherein the catalyst comprises a Lewis acid.

25. The method according to claim 24, wherein the Lewis acid comprises an aluminum ion, a zinc ion, a metal salt having an aluminum ion or a zinc ion, or a metal complex having an aluminum ion or a zinc ion.

26. The method according to claim 20, wherein the first film comprises a polyvinyl alcohol film surface-modified to have carboxylic groups on the surface.

27. The method according to claim 20, wherein the second film comprises an alkaline solution-dipped cellulose film, a derivative of an alkaline solution-dipped cellulose film, a polyvinyl ester hydrolysate, partially dehydrated PVA film, a plasma- or corona-treated film, a film coated with a polymer having hydroxyl groups, or a film coated with a resin having hydroxyl groups.

28. The method according to claim 27, wherein the cellulose film comprises a triacetyl cellulose (TAC) film or a diacetyl cellulose (DAC) film.

29. The method according to claim 27, wherein the plasma- or corona-treated film comprises cyclic olefin polymer (COP), polycarbonate (PC), or cyclic olefin copolymer (COC).

30. The method according to claim 20, before performing a thermocompression lamination, further comprising a step of adding a wetting liquid between the first film and the second film.

31. The method according to claim 30, wherein the wetting liquid comprises water, or an organic solvent having a low boiling point.

32. The method according to claim 30, wherein the wetting liquid comprises a catalyst for catalyzing a reaction between a hydroxyl group and a carboxylic group to form an ester group.

33. The method according to claim 32, wherein the catalyst comprises a protic acid or a Lewis acid.

34. The method according to claim 20, before performing the thermocompression lamination, further comprising a step of preheating the second film.
